(19) United States
(12) Patent Application Publication
(10) Pub. No.: US 2015/0257378 A1
(43) Pub. Date: Sep. 17, 2015

(54) PHEROMONE ATTRACTANTS FOR TAWNY CRAZY ANTS

(71) Applicant: STERLING INTERNATIONAL INC., Spokane, WA (US)

(72) Inventors: Qing-He Zhang, Greenacres, WA (US); Rodney G. Schneidmiller, Greenacres, WA (US)

(73) Assignee: STERLING INTERNATIONAL INC., Spokane, WA (US)

(21) Appl. No.: 14/657,935

(22) Filed: Mar. 13, 2015

Related U.S. Application Data
(60) Provisional application No. 61/953,690, filed on Mar. 14, 2014.

(51) Int. Cl. A01M 1/20; A01M 1/22; A01N 35/02; A01N 27/00; A01M 1/02; A01M 1/10

(52) U.S. Cl. CPC A01M 1/2011; A01M 1/02; A01M 1/103; A01M 1/2022; A01N 35/02; A01N 27/00; A01M 1/223

(57) ABSTRACT

Provided herein are pheromone attractant compositions for tawny crazy ants. The pheromone attractant compositions can include one or more of n-undecane, 2-tridecanone, n-decane, 1-undecene, n-tridecane, 2-dodecanone, 2-tetradecanone, 2-pentadecanone, and formic acid. The pheromone attractant compositions can be formulated into controlled release formulations, incorporated into traps, bait stations, gel or granular baits, or insecticidal sprays, and used to trap or kill tawny crazy ants and their colonies.

### CROSS-REFERENCE TO RELATED APPLICATION

This application claims the benefit of U.S. Patent Application No. 61/953,690, filed Mar. 14, 2014, the disclosure of which is incorporated by reference herein in its entirety.

### BACKGROUND

The tawny crazy ant, Nylanderia fulva (Mayr) (Hymenoptera: Formicidae), is a serious economically and ecologically important invasive pest in the southern U.S. It was first found around Houston (Harris County), Texas, in 2002, and has begun to spread largely through human assistance. At present, it has been discovered in Florida, southwestern Mississippi, Louisiana, and lately in Georgia. The exact native range is not known, but it is likely that N. fulva is native to South America. Over the past five years, this crazy ant has been referred to with many other names, including Rasberry crazy ant, invasive crazy ant, brown crazy ant, Caribbean crazy ant, hairy crazy ant, Nylanderia (Paratrechina) sp. nr. pubens, or Nylanderia pubens, before it was finally identified as Nylanderia fulva (Mayr). The current common name, tawny crazy ant, was proposed and approved officially by the Entomological Society of America in May 2013.

The tawny crazy ant is a very successful invasive species in the southern states, likely due to its omnivorous feeding habits, polydomous nesting, extreme polygyny, high fecundity, high interspecific aggression, and lack of intraspecific aggression. The extremely high population densities of N. fulva have caused great annoyance to residents and businesses in infested areas. For example, large numbers of tawny crazy ants have accumulated in electrical equipment, causing short circuits and clogging switching mechanisms, resulting in equipment failure. Field observations suggest that N. fulva displace the red imported fire ant (Solenopsis invicta Buren) and most other ant species in areas of heavy infestation through exploitative and interference competition, and an efficient detoxification mechanism against the insecticidal alkaloid-based fire ant venom.

The tawny crazy ant species is an extremely effective hunter and scavenger, and could rapidly and erratically recruit workers to large food items and to food sources far from its nests for cooperative transport/foraging. Such rapid and efficient recruitments can involve a traditional trail pheromone (e.g., semi-volatile pheromones for long lasting trail, or volatile pheromones for short-lived trail) laid by the returning ants, and/or a point-source volatile pheromone attractant released by the scout ants. The point-source volatile pheromone attractant can quickly recruit nearby nestmate foragers outside the nest. Without wishing to be bound by theory, it is believed that the point-source volatile pheromone attractant may function in long-range efficient mass recruitments for large food foraging. The point-source volatile pheromone attractant can also elicit urgent help for defense or actively mass-attacking competitors. The point-source volatile pheromone attraction for rapid and massive recruitments at short (<2 m), medium (2-6 m), or even long range (>6 m) can be a unique chemical communication mechanism that enables crazy ants to outcompete other ant species by exploiting food sources (group hunting or cooperative transport) more rapidly and by implementing group defense more effectively, and therefore contribute to their significant success as aggressive invaders.

Without wishing to be bound by theory, it is believed that chemical communication is most elaborate and much more advanced in ants compared to solitary insects, and even more than in other social insects. Semiochemicals, especially pheromones, can play a critical role in the organization of ant societies. These pheromone chemicals are produced in, and often stored by various exocrine glands (e.g., metapleural glands, Dufour's glands, mandibular glands, venom/poison glands, hindgut, postpharyngeal gland, pygidial gland, Pavan's gland, and tibial glands). However, in different ant species, the same compound can be found in different glands and serve different functions; and the same gland system can produce different volatile chemicals in different species for different purposes. The chemical compositions of various gland systems and their functions show extremely high diversity, vary greatly with ant species, and are therefore unpredictable.

As a major part of ant control operations, commercial insecticidal toxic baits have been commonly used in both urban and agricultural settings. Current commercially available baits for ant control are food-based and include gel baits, liquid baits, and/or solid granular baits. In general, a liquid or gel bait requires a bait station and constant reapplication whereas the solid baits can be broadcast over larger areas. The commercially available baits include an attractant, which can be food-based (i.e., a food bait) and can include proteins, carbohydrates, and/or lipids; a carrier; and active insecticide ingredient(s). However, it is believed that synthetic ant pheromones have not been incorporated into ant bait stations and trapping systems due to the lack of significant point-source attractions.

Synthetic trail pheromone of the Argentine ant (Linepithema humile (Mayr)), Z-9-hexadecenal, was reported to increase the consumption of sugar-based liquid baits by ant workers when it is mixed with the baits (Greenberg and Klotz 2000. Journal of Economic Entomology 93,119-122). Z-9-hexadecenal was also reported to increase the killing efficacy of insecticides against L. humile workers when mixed in insecticide sprays (Choe et al. 2014. Journal of Economic Entomology 107, 319-325), and this pheromone compound was tested as a behavior-disrupting agent in a microencapsulated sprayable formulation to disrupt trail following and foraging in Argentine ants, as described, for example, in Suckling et al. (2012), Pest Management Science 68, 1572-1578 and U.S. Pat. No. 8,278,360. The feasibility of using aerosol for delivery of the red import fire ant trail pheromone, (Z,E)-α-farnesene, was also demonstrated, for example, in Suckling et al. (2012), Pest Management Science 68:1572-1578, but the need for high purity combined with the difficulty of commercial supply of (Z,E)-α-farnesene makes this technique impractical. Thus, development of a synthetic pheromone attractant system with significant point-source attraction at medium or long range (2-6 meters or longer) is urgently needed for invasive species such as crazy ants. Such synthetic pheromone attractants can be useful not only for pheromone-baited traps for monitoring the spreading of the crazy ants, but also can improve the performance of various ant baits by adding the powerful synthetic pheromones to the baiting system.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, this disclosure features a tawny crazy ant attractant including a first composition including a pheromone component that includes n-undecane.

In yet another aspect, this disclosure features a tawny crazy ant attractant including a first composition including pheromone components that include n-undecane and 2-tridecanone.

In yet another aspect, this disclosure features a tawny crazy ant attractant including a first composition including pheromone components that include n-undecane, 2-tridecanone, n-tridecane, and 2-pentadecanone.

In yet another aspect, this disclosure features a tawny crazy ant attractant including a first composition including pheromone components that include n-undecane, 2-tridecanone, n-decane, 1-undecene, n-tridecane, 2-dodecanone, 2-tetradecanone, and 2-pentadecanone.

In yet another aspect, this disclosure features a tawny crazy ant attractant including a first composition including one or more pheromone components selected from n-undecane, 2-tridecanone, n-decane, 1-undecene, n-tridecane, 2-dodecanone, 2-tetradecanone, and 2-pentadecanone.

In any of the above-described compositions, the first composition can further include a first carrier in addition to the one or more pheromone components.

In yet another aspect, this disclosure features a tawny crazy ant attractant including a first composition including a first carrier and one or more pheromone components including n-undecane and 2-tridecanone; and a second composition including a second carrier and formic acid,

In yet another aspect, this disclosure features a tawny crazy ant attractant including a first composition including a first carrier and one or more pheromone components including n-undecane, 2-tridecanone, n-tridecane and 2-pentadecanone; and a second composition including a second carrier and formic acid.

In yet another aspect, this disclosure features a tawny crazy ant attractant including a first composition including a first carrier and one or more pheromone components including n-undecane, 2-tridecanone, n-decane, 1-undecene, n-tridecane, 2-dodecanone, 2-tetradecanone, and 2-pentadecanone; and a second composition including a second carrier and formic acid.

In yet another aspect, this disclosure features a formulation including any one of the tawny crazy ant attractants above, a toxicant, and a food bait, such as a granular food bait for use in broadcasting or a gel food bait in syringe for direct application at corners or into cracks and crevices.

In yet another aspect, this disclosure features a formulation including any one of the tawny crazy ant attractants above and an insecticide or toxicant spray solution, to provide a pheromone-enhanced insecticide formulation. The pheromone-enhanced insecticide formulation can be used to improve a barrier control efficacy.

In yet another aspect, this disclosure features a device including any of the tawny crazy ant attractants above. The device includes a first dispenser including the first composition including n-undecane, or n-undecane and 2tridecanone in the first carrier; and a second dispenser including the second composition including formic acid in the second carrier. The device can be a tawny crazy ant attraction device.

In yet another aspect, this disclosure features a method for attracting a tawny crazy ant, including providing a device including any one of the tawny crazy ant attractants above; and attracting a tawny crazy ant to the device.

In yet another aspect, this disclosure features a method of attracting tawny crazy ants, including providing any of the tawny crazy ant attractants above in a device, placing the device in a location frequented by tawny crazy ants; and attracting the tawny crazy ants to the device.

In yet another aspect, this disclosure features a method of attracting tawny crazy ants, including providing a composition that includes n-undecane, or n-undecane and 2-tridecanone in a first carrier; placing the composition in a location frequented by tawny crazy ants; and attracting the tawny crazy ant to the device. In some embodiments, the composition consists essentially of n-undecane (or n-undecane and 2-tridecanone) in a first carrier.

Embodiments include one or more of the following features, in any combination.

The composition (e.g., the first and/or second composition) can be formulated into a controlled release formulation, such that the one or more pheromone components in a given controlled release composition can volatilize, for example, at a rate of from 0.1 mg/day to 1 g/day (e.g., 0.1 mg/day to 100 mg/day, 0.1 mg/day to 10 mg/day, 0.1 mg/day to 15 mg/day, 0.1 mg/day to 50 mg/day, 0.1 mg/day to 15 mg/day, 5 mg/day to 12 mg/day, 8 mg/day to 12 mg/day, 27 mg/day to 30 mg/day, 30 mg/day to 50 mg/day, 5 mg/day to 500 mg/day, 1 mg/day to 100 mg/day, 10 mg/day to 100 mg/day, or 20 mg/day to 100 mg/day). The one or more pheromone components in the first composition can volatilize from a first dispenser. The formic acid in the second composition can volatilize from a second dispenser.

In some embodiments, when the one or more pheromone components in the first composition include n-undecane and 2-tridecanone, the n-undecane is present in an amount of from 50% to 90% by weight, based on the total weight of the one or more pheromone components in the first composition. The 2-tridecanone can be present in an amount of from 10% to 50% by weight, based on the total weight of the one or more pheromone components in the first composition.

In some embodiments, when the one or more pheromone components in the first composition include n-undecane, 2-tridecanone, n-tridecane, and 2-pentadecanone, the n-undecane can be present in an amount of from 20% to 80% by weight (e.g., 49.8% to 89.8% by weight), based on the total weight of the one or more pheromone components in the first composition. The 2-tridecanone can be present in an amount of from 20% to 70% by weight (e.g., 10% to 50% by weight), based on the total weight of the one or more pheromone components in the first composition. The n-tridecane can be present in an amount of from 0.1% to 30% by weight (e.g., 0.1% to 2.5% by weight), based on the total weight of the one or more pheromone components in the first composition. The 2-pentadecanone can be present in an amount of from 0.1% to 30% by weight (e.g., 0.1% to 2.5% by weight), based on the total weight of the one or more pheromone components in the first composition.

In some embodiments, when the one or more pheromone components in the first composition include n-undecane, 2-tridecanone, n-decane, 1-undecene, n-tridecane, 2-dodecanone, 2-tetradecanone, and 2-pentadecanone, the n-undecane can be present in an amount of from 45% to 90% by weight (e.g., 49.4% to 89.4% by weight), based on the total weight of the one or more pheromone components in the first composition. The 2-tridecanone can be present in an amount of from 10% to 50% by weight, based on the total weight of the one or more pheromone components in the first composition. The n-tridecane can be present in an amount of from 0.1% to 5% by weight, based on the total weight of the one or more pheromone components in the first composition. The 2-pentadecanone can be present in an amount of from 0.1% to 5% by weight, based on the total weight of the one or more pheromone components in the first composition. The n-decane can be present in an amount of from 0.1% to 5% by weight, based on the total weight of the one or more pheromone components in the first composition. The 1-undecene can be present in an amount of from 0.1% to 5% by weight, based on the total weight of the one or more pheromone components in the first composition. The 2-dodecanone can be present in an amount of from 0.1% to 5% by weight, based on the total weight of one or more pheromone components in the first composition.

The 2-tetradecanone can be present in an amount of from 0.1% to 5% by weight, based on the total weight of one or more pheromone components in the first composition.

In any of the compositions above, the weight percentages of all the components of a given composition, when added together, equal 100% by weight, based on the total weight of the given composition.

The tawny crazy ant attractant can include a synergistic composition(s), such that two or more pheromone components attract tawny crazy ants in a number that is more than the additive attractive effect of the individual components. The tawny crazy ant attractant can be contained in and released from a centrifuge tube, stickpack dispenser, polyethylene bag, polymer bead, or rubber septum.

In some embodiments, the first carrier is a vegetable oil or a mineral oil. For example, the vegetable oil can include canola oil and/or soybean oil. In some embodiments, the second carrier can include a polymer, such as a polyurethane (e.g., a crosslinked polyurethane).

In some embodiments, the device is a trap (e.g., a sticky trap, a non-sticky trap such as an electric zapper). The device can include a device that can generate an electromagnetic field. The device can include a bait station, which can include a solid, paste, liquid, or gel food bait. The food bait can be mixed with the toxicant or be separate from the toxicant. The food bait can be disposed on a substrate. In some embodiments, the bait station does not include a food bait.

In some embodiments, the device (e.g., a bait station) further comprises a toxicant, such as fipronil, boric acid, sodium tetraborate, disodium octaborate tetrahydrate, hydramethylnon, indoxacarb, dinotefuran, abamectin, fenoxycarb, spinosad, propoxur, methoprene, or any combination thereof.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A and 1B are gas chromatography-mass spectrometry total ion chromatograms (TIC) of N. fulva whole body (Dufour's gland) pentane extracts. 1A: five workers; 1B: one queen. An internal standard (IS) of 10 μg of octyl butyrate was added to each sample before GC-MS analysis.

FIGS. 2A and 2B are gas chromatography-mass spectrometry total ion chromatograms (TIC) of N. fulva whole body (Dufour's and poison glands) methanol extracts. 2A: five workers; 2B: one queen. An internal standard (IS) of 10 μg of octyl butyrate was added to each sample before GC-MS analysis.

FIG. 3 is a table of volatile compounds identified from N. fulva whole body pentane extracts.

FIG. 4 is a table showing behavioral responses of N. fulva workers to Dufour's gland pheromone candidates in summer.

FIG. 5 is a table showing behavioral responses of N. fulva workers to Dufour's gland pheromone candidates in fall.

FIG. 6 is a table showing behavioral responses of N. fulva workers to Dufour's gland pheromone candidates and/or to poison gland pheromone candidates in late fall.

FIG. 7 a table showing behavioral responses of N. fulva workers to Dufour's gland pheromone candidates and/or to poison gland pheromone candidates in summer.

FIG. 8 is a table showing behavioral responses of N. fulva to three major Dufour's/poison gland pheromone components in late summer.

FIG. 9 is a table showing the results of tests of between-subject effects by factorial ANOVA on the relative catches of N. fulva from Experiment 8.

FIG. 10 is a table showing behavioral responses of N. fulva to two Dufour's/poison gland pheromone candidate mixtures vs. n-undecane alone in fall.

### DETAILED DESCRIPTION

Pheromone attractant compositions can be used to attract tawny crazy ants. The pheromone attractant compositions described herein can be readily available and can be implemented as a point-source attractant in ant traps, baits, bait stations, and applications where tawny crazy ant attraction is desired. The pheromone components in the attractant compositions described herein can act in a synergistic manner, where a combination of a mixture two or more pheromone components can attract more tawny crazy ants than the additive ant attraction for each separate component. In some embodiments, a single pheromone component is effective in attracting tawny crazy ants. The pheromone attractant compositions are tailored specifically to the tawny crazy ant, such that other ant species are not significantly attracted by the pheromone attractant composition.

As used herein, a point-source volatile pheromone attractant is a pheromone attractant that is released by individual scout ants (i.e, foragers) into air to attract nestmates or other foragers in the vicinity (e.g., downwind of the point source) toward the point source. The point-source volatile pheromone attractant is different from a common trail pheromone that is laid by scout ants on the ground as a trail (i.e., a linear source pheromone) from the prey to the nest.

### Pheromone Attractant Compositions

The pheromone attractant composition can include, can consist essentially of, or consist of one or more pheromone components selected from n-undecane, 2-tridecanone, n-decane, 1-undecene, n-tridecane, 2-dodecanone, 2-tetradecanone, 2-pentadecanone, and formic acid. For example, in some embodiments, the pheromone attractant composition includes a single pheromone component, such as n-undecane. In some embodiments, the pheromone attractant composition can include a mixture of n-undecane and 2-tridecanone; or a mixture of n-undecane, 2-tridecanone, and formic acid. In some embodiments, in addition to n-undecane and 2-tridecanone, the pheromone attractant composition can include n-tridecane and 2-pentadecanone. In some embodiments, the pheromone attractant composition includes n-undecane, 2-tridecanone, n-tridecane, 2-pentadecanone, and formic acid. In some embodiments, in addition to n-undecane, 2-tridecanone, n-tridecane, and 2-pentadecanone, the pheromone attractant composition can include n-decane, 1-undecene, 2-dodecanone, and 2-tetradecanone. In some embodiments, the pheromone attractant composition includes n-undecane, 2-tridecanone, n-tridecane, 2-pentadecanone, n-decane, 1-undecene, 2-dodecanone, 2-tetradecanone, and formic acid. The pheromone components of the pheromone attractant composition can interact in a synergistic manner.

When the pheromone attractant composition includes formic acid, the formic acid can be combined with the other pheromone components of the pheromone attractant composition in a single dispenser or can be contained in a separate dispenser. In some embodiments, formic acid is preferentially contained in a separate dispenser from the remaining pheromone components of the pheromone attractant composition. The separate dispenser containing the formic acid can be placed in close proximity (e.g., next to, or immediately next to) the dispenser including the other pheromone components.

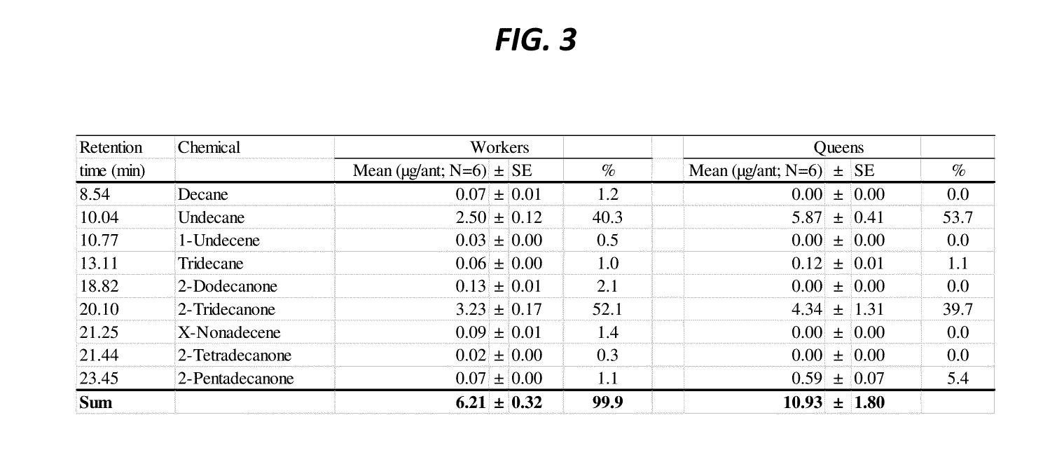

The pheromone components in the pheromone attractant composition can be present, for example, at percentages by weight that are different from naturally-occurring ranges (shown, for example, in FIG. 3). In other embodiments, the pheromone components in the pheromone attractant composition can occur at about naturally occurring weight percentages. The weight percentages of the pheromone components of a given pheromone attractant composition of the present disclosure can vary, but equal 100% by weight when added together, based on the total weight of the composition. The weight percentages of each of the pheromone components of the pheromone attractant composition will be described below.

In some embodiments, the pheromone attractant composition includes n-undecane. The pheromone attractant composition can include n-undecane in an amount of from 10% by weight (e.g., 25% by weight, 50% by weight, or 75% by weight) to 99% by weight (e.g., 75% by weight, 50% by weight, or 25% by weight), based on the total weight of the pheromone components in the composition. In some embodiments, the pheromone attractant composition includes 20%-80% (e.g., 40%-80%, 60%-80%, or 70%-80%) by weight n-undecane, based on the total weight of the pheromone components in the composition. In some embodiments, the pheromone attractant composition includes only n-undecane as a pheromone component, such that the composition includes n-undecane at 100% by weight.

In some embodiments, the pheromone attractant composition includes 2-tridecanone. The pheromone attractant composition can include 2-tridecanone in an amount of from 10% by weight (e.g., 25% by weight, 30% by weight, 40% by weight, or 50% by weight) to 70% by weight (e.g., 50% by weight, 40% by weight, 30% by weight, or 25% by weight), based on the total weight of the pheromone components in the composition. In some embodiments, the pheromone attractant composition includes 10%-50% (e.g., 10%-40%, 10%-30%, or 10%-20%) by weight 2-tridecanone, based on the total weight of the pheromone components in the composition.

In some embodiments, the pheromone attractant composition includes n-decane. The pheromone attractant composition can include n-decane in an amount of from 0.1% by weight (e.g., 5% by weight, 15% by weight, or 20% by weight) to 30% by weight (e.g., 20% by weight, 15% by weight, or 5% by weight), based on the total weight of the pheromone components in the composition. In some embodiments, the pheromone attractant composition includes n-decane in an amount of 0.5%-5% (e.g., 0.25% to 2.5%, 0.5%-3%, 1%-5%, 1%-4%, or 1%-3%) by weight, based on the total weight of the pheromone components in the composition.

In some embodiments, the pheromone attractant composition includes 1-undecene. The pheromone attractant composition can include 1-undecene in an amount of from 0.1% by weight (e.g., 5% by weight, 15% by weight, or 20% by weight) to 30% by weight (e.g., 20% by weight, 15% by weight, or 5% by weight), based on the total weight of the pheromone components in the composition. In some embodiments, the pheromone attractant composition includes 1-undecene in an amount of 0.5%-5% (e.g., 0.25% to 2.5%, 0.5%-3%, 1%-5%, 1%-4%, or 1%-3%) by weight, based on the total weight of the pheromone components in the composition.

In some embodiments, the pheromone attractant composition includes n-tridecane. The pheromone attractant composition can include n-tridecane in an amount of from 0.1% by weight (e.g., 5% by weight, 15% by weight, or 20% by weight) to 30% by weight (e.g., 20% by weight, 15% by weight, or 5% by weight), based on the total weight of the pheromone components in the composition. In some embodiments, the pheromone attractant composition includes n-tridecane in an amount of 0.5%-5% (e.g., 0.25% to 2.5%, 0.5%-3%, 1%-5%, 1%-4%, or 1%-3%) by weight, based on the total weight of the pheromone components in the composition.

In some embodiments, the pheromone attractant composition includes 2-dodecanone. The pheromone attractant composition can include 2-dodecanone in an amount of from 0.1% by weight (e.g., 5% by weight, 15% by weight, or 20% by weight) to 30% by weight (e.g., 20% by weight, 15% by weight, or 5% by weight), based on the total weight of the pheromone components in the composition. In some embodiments, the pheromone attractant composition includes 2-dodecanone in an amount of 0.5%-5% (e.g., 0.25% to 2.5%, 0.5%-3%, 1%-5%, 1%-4%, or 1%-3%) by weight, based on the total weight of the pheromone components in the composition.

In some embodiments, the pheromone attractant composition includes 2-tetradecanone. The pheromone attractant composition can include 2-tetradecanone in an amount of from 0.1% by weight (e.g., 5% by weight, 15% by weight, or 20% by weight) to 30% by weight (e.g., 20% by weight, 15% by weight, or 5% by weight), based on the total weight of the pheromone components in the composition. In some embodiments, the pheromone attractant composition includes 2-tetradecanone in an amount of 0.5%-5% (e.g., 0.25% to 2.5%, 0.5%-3%, 1%-5%, 1%-4%, or 1%-3%) by weight, based on the total weight of the pheromone components in the composition.

In some embodiments, the pheromone attractant composition includes 2-pentadecanone. The pheromone attractant composition can include 2-pentadecanone in an amount of from 0.1% by weight (e.g., 5% by weight, 15% by weight, or 20% by weight) to 30% by weight (e.g., 20% by weight, 15 wt %, or 5 wt %), based on the total weight of the pheromone components in the composition. In some embodiments, the pheromone attractant composition includes 2-pentadecanone in an amount of 0.5%-5% (e.g., 0.25% to 2.5%, 0.5%-3%, 1%-5%, 1%-4%, or 1%-3%) by weight, based on the total weight of the pheromone components in the composition.

In some embodiments, the pheromone attractant composition includes, consists essentially of, or consists of, n-undecane and 2-tridecanone. The n-undecane can be present in an amount of from 50% to 90% by weight. The 2-tridecanone can be present in an amount of from 10% to 50% by weight. In some embodiments, the ratio of n-undecane to 2-tridecanone in the composition can range from 5:5 (e.g., 6:4, 7:3, 8:2) to 9:1 (e.g., 8:2, 7:3, or 6:4). For example, the ratio of n-undecane to 2-tridecanone in the composition can be 1:1. In some embodiments, the ratio of n-undecane to 2-tridecanone in the composition is 4:1.

In some embodiments, the pheromone attractant composition includes, consists essentially of, or consists of n-undecane, 2-tridecanone, n-tridecane and 2-pentadecanone. The n-undecane can be present in an amount of from 49.8% to 89.8% by weight. The 2-tridecanone can be present in an amount of from 10% to 50% by weight. The n-tridecane can be present in an amount of from 0.1% to 2.5% by weight (e.g., from 0.25% to 2.5% by weight). The 2-pentadecanone can be present in an amount of from 0.1% to 2.5% by weight (e.g., from 0.25% to 2.5% by weight).

In some embodiments, the pheromone attractant composition includes, consists essentially of, or consists of n-undecane, 2-tridecanone, n-decane, 1-undecene, n-tridecane, 2-dodecanone, 2-tetradecanone, and 2-pentadecanone. The n-undecane can be present in an amount of from 49.4% to 89.4% by weight. The 2-tridecanone can be present in an amount of from 10% to 50% by weight. The n-decane can be present in an amount of from 0.1% to 5% by weight. The 1-undecene can be present in an amount of from 0.1% to 5% by weight. The n-tridecane can be present in an amount of from 0.1% to 5% by weight. The 2-dodecanone can be present in an amount of from 0.1% to 5% by weight. The 2-tetradecanone can be present in an amount of from 0.1% to 5% by weight. The 2-pentadecanone can be present in an amount of from 0.1% to 5% by weight. In some embodiments, the pheromone attractant composition includes n-undecane, 2-tridecanone, n-tridecane, 2-pentadecanone, n-decane, 1-undecene, 2-dodecanone, and 2-tetradecanone, respectively, in an amount of 70.25, 23.25, 1.5, 0.5, 2, 0.75, 1, and 0.25% by weight.

In some embodiments, for any of the above-described compositions, the pheromone attractant composition further includes formic acid, which can be combined with the other pheromone components of the pheromone attractant composition in a same dispenser, or preferably added to the composition in a separate dispenser. When the formic acid is added to the pheromone attractant composition in a separate dispenser, the amount of formic acid compared to the remaining pheromone attractants can be unimportant so long as the formic acid is released at a desired release rate over a desired period, as will be discussed in greater detail below.

In some embodiments, when the formic acid is combined with, or added to, the other pheromone components of the pheromone attractant composition, the composition includes formic acid in an amount of from 10% by weight (e.g., 25% by weight, 50% by weight, or 75% by weight) to 99% by weight (e.g., 75% by weight, 50% by weight, or 25% by weight), based on the total weight of the pheromone components in the composition. In some embodiments, the pheromone attractant composition includes 30%-80% (e.g., 40%-80%, 50%-80%, or 60%-80%) by weight formic acid, based on the total weight of the pheromone components in the composition.

In some embodiments, the pheromone attractant composition includes formic acid, n-undecane and 2-tridecanone, respectively, in an amount of about 65%-70% (e.g., 68%) by weight, 20%-25% (e.g., 24%) by weight, and 5%-15% (e.g., 8%) by weight. In some embodiments, the pheromone attractant composition includes formic acid, n-undecane and 2-tridecanone, respectively, in an amount of 68.65% by weight, 23.51% by weight, and 7.84% by weight. In some embodiments, the pheromone attractant composition includes formic acid in an amount of 65%-70% by weight, n-undecane in an amount of 20%-23% by weight, 2-tridecanone in an amount of 5%-10% by weight, and n-tridecane, 2-pentadecanone, n-decane, 1-undecene, 2-dodecanone, and 2-tetradecanone in a combined amount of 1%-5% by weight. In some embodiments, the pheromone attractant composition includes formic acid, n-undecane, 2-tridecanone, n-tridecane, 2-pentadecanone, n-decane, 1-undecene, 2-dodecanone, and 2-tetradecanone, respectively, in an amount of 68.64, 22.18, 7.29, 0.47, 0.16, 0.63, 0.24, 0.31 and 0.08% by weight.

### Formulations

The pheromone attractant compositions, as described above, can be combined with one or more carriers, antioxidants, and/or preservatives to form a formulation. The formulation can be in the form of a liquid, paste, solid, or gel. In some embodiments, the formulation is a controlled release formulation, such that the pheromone attractant composition can be released over a period of time. Exemplary carriers for pheromone attractant compositions include oils; a solid substrate such as fibers (e.g., cotton fibers, felts); polymers (e.g., polyethylene glycol, polymethacrylates, ethylene-vinyl acetate copolymers, poly(acrylic acid), polyolefins (e.g., polypropylene), poly(urethane), silicones, lactic and glycolic acid-based polymers, and copolymers thereof); beads (e.g., polymer beads); microcapsules (e.g., silica microcapsules); glasses; a gel; and ceramics. In some embodiments, when the carrier is a solid substrate, such as fibers, polymers, microcapsules, glasses, or ceramics, the pheromone attractant composition can be infused into the substrate to provide a controlled release composition. In some embodiments, a polymeric carrier can be a porous plastic substrate.

Exemplary oils to use with pheromone attractant compositions include, but are not limited to, oils derived from plants such as vegetable oils and nut oils, or non-plant derived oils such as mineral oils. These are widely available and cost-effective. Formulations can include oils such as canola oil, cottonseed oil, palm oil, safflower oil, soybean oil, corn oil, olive oil, peanut oil, sunflower oil, sesame oil, nut oils, and coconut oils. Nut oils include, but are not limited to, almond oil, cashew oil, hazelnut oil, macadamia oil, mongongo nut oil, pecan oil, pine nut oil, pistachio oil, sacha inchi oil, and walnut oil. Melon and gourd seed oils are very common and inexpensive. The oils listed above include saturated, monounsaturated, and polyunsaturated fatty acids that are soluble in many compositions, especially the less polar or non-polar ones. The mineral oils are relatively inexpensive and can be used as carriers for less polar or non-polar pheromone attractant compositions.

In some embodiments, a pheromone attractant composition that includes one or more of n-undecane, 2-tridecanone, n-decane, 1-undecene, n-tridecane, 2-dodecanone, 2-tetradecanone, and 2-pentadecanone is combined with a first carrier to provide a first formulation. The first carrier can be miscible with the pheromone components and can provide a homogeneous composition having a desired release rates over a period of 3 to 30 days. The first carrier can be relatively non-polar. In some embodiments, the first carrier is an oil, such as vegetable oils or mineral oils. In some embodiments, the first oil is canola oil. In certain embodiments, the release rate of pheromone components at the end of a period of 3 to 30 days is greater than the active threshold release rate. As used herein, the active threshold release rate is the minimum release rate for significant insect attraction. The active threshold release rate can be determined by a dose-response test with a series of release rates ranging from very low to very high.

In some embodiments, a pheromone attractant composition that includes one or more of n-undecane, 2-tridecanone, n-decane, 1-undecene, n-tridecane, 2-dodecanone, 2-tetradecanone, and 2-pentadecanone can be separated into two or more separate formulations. For example, the pheromone attractant composition can include n-undecane in a first formulation, and 2-tridecanone in a second formulation, where the formulations differ in carrier and/or pheromone concentration. The two or more formulations can work together synergistically to attract tawny crazy ants, so long as they are placed in close proximity to (e.g., next to, or immediately next to) one another. In some embodiments, the pheromone attractant composition can further include formic acid, which can be mixed with one or more of the formulations containing one or more n-undecane, 2-tridecanone, n-decane, 1-undecene, n-tridecane, 2-dodecanone, 2-tetradecanone, and 2-pentadecanone, or the formic acid can be separately contained. In some embodiments, a pheromone attractant composition that includes formic acid is combined with a second carrier to provide a second formulation. The second carrier can be miscible with formic acid and can provide a homogeneous composition having a desired release rate over a desired period (e.g., 3 to 30 days). The second carrier is different from the first carrier and can be, for example, a polyurethane (e.g., a crosslinked polyurethane).

Exemplary preservatives include, for example, sorbic acid and its salts, benzoic acid and its salts, calcium propionate, sodium nitrite, sulfites (sulfur dioxide, sodium bisulfite, potassium hydrogen sulfite, etc.) and disodium ethylenediaminetetraacetic acid (EDTA). Other exemplary preservatives include ethanol and methylchloroisothiazolinone, rosemary extract, hops, salt, sugar, vinegar, alcohol, diatomaceous earth and castor oil, citric and ascorbic acids, vitamin C, and vitamin E.

Exemplary antioxidants for use with the pheromone attractant composition include, but are not limited to, tocopherols (e.g., α-tocopherol, γ-tocopherol, etc), ascorbic acid, as well as synthetic antioxidants such as propyl gallate, tertiary butylhydroquinone, butylated hydroxytoluene (BHT), butylated hydroxyanisole (BHA), phenolic alcohols, flavonoids, catechins, related molecules thereof, and anthocyanins and their glycosides. The antioxidants can be soluble in most of the compositions and can react efficiently with oxygen in the dispensing systems, and therefore offer a way to decrease oxidation, breakdown, and polymerization of the pheromone attractant compositions. In some embodiments, the oxidant can also be a preservative.

While representative carriers, preservatives, and antioxidants have been listed above, it is to be appreciated that other carriers, preservatives, and antioxidants not specifically listed above can also be used.

In some embodiments, the formulation further includes a toxicant (i.e., an insecticide). Exemplary non-limiting toxicants include fipronil, boric acid, sodium tetraborate, disodium octaborate tetrahydrate, hydramethylnon, indoxacarb, dinotefuran, abamectin, fenoxycarb, spinosad, propoxur, methoprene, or any combination thereof. The formulation can be contained in various dispensers. Non-limiting examples of dispensers include centrifuge tubes, stickpack dispensers, polyethylene bags, porous plastics, polymeric beads, rubber septa, and syringes. For example, the formulation can be absorbed into a polymeric bead or a rubber septum. The formulation can be loaded into a centrifuge tube, stickpack dispenser, or polyethylene bag.

In some embodiments, the formulation is a controlled release formulation. In some embodiments, the controlled release formulation includes a pheromone attractant composition (which can include one or more of a pheromone component selected from n-undecane, 2-tridecanone, n-decane, 1-undecene, n-tridecane, 2-dodecanone, 2-tetradecanone, 2-pentadecanone, and formic acid) that can slowly evaporate (i.e., volatilize) over time. In some embodiments, the controlled release formulation can alternatively or additionally be contained in a dispenser (e.g., a porous container, a porous bag) that allows the slow evaporation of the pheromone attractant composition over time. For example, the pheromone components of a given pheromone attractant composition can volatilize at a cumulative rate of from 0.1 mg/day (e.g., 10 mg/day, 50 mg/day, 100 mg/day, or 500 mg/day) to 1 g/day (e.g., 500 mg/day, 100 mg/day, 50 mg/day, or 10 mg/day), over a period of, for example, 3 days to 30 days (e.g., 3 days to 7 days, 3 days to 10 days, 3 days to 25 days, or 3 days to 20 days). In some embodiment, the pheromone components of a given pheromone attractant composition can volatilize at a cumulative rate of from 0.1 mg/day to 1 g/day (e.g., 0.1 mg/day to 100 mg/day, 0.1 mg/day to 10 mg/day, 0.1 mg/day to 15 mg/day, 0.1 mg/day to 50 mg/day, 0.1 mg/day to 15 mg/day, 5 mg/day to 12 mg/day, 8 mg/day to 12 mg/day, 27 mg/day to 30 mg/day, 30 mg/day to 50 mg/day, 5 mg/day to 500 mg/day, 1 mg/day to 100 mg/day, 10 mg/day to 100 mg/day, or 20 mg/day to 100 mg/day) over a period of, for example, 3 days to 30 days.

Without wishing to be bound by theory, it is believed that the pheromone components in the pheromone attractant composition are highly attractive to tawny crazy ants, even though the release rate is hundreds to thousands fold greater than the release rate of the corresponding pheromone components released by individual ants in nature. Indeed, it is known that many attractive pheromones become inactive or repellent at high release rates, as described, for example, in Miller, D. R. et al., Lindgren, B. S., and Borden, J. H. 2005, Environmental Entomology, 34:1019-1027; Mashaly, A. M. A. et al., 2011, Journal of Insect Science, 11(1), 31. doi:10.1673/031.011. Thus, it is both surprising and unexpected that the present pheromone attractant compositions have enhanced attractive properties to tawny crazy ants at high release rates.

### Traps and Bait Stations

The pheromone attractant compositions and formulations described above can be incorporated into a trap, bait, and/or bait station. In some embodiments, a trap (e.g., a tawny crazy ant trap) is configured to enclose an ant. The trap can include an adhesive trap (i.e., a sticky trap). In some embodiments, the tawny crazy ant trap is a non-adhesive trap, such as an electric zapper. In some embodiments, the tawny crazy ant trap can provide a source of electricity, such that tawny crazy ants can be electrocuted on contact with the electricity. In some embodiments, the trap includes one or more dispensers (e.g., a tube such as a centrifuge tube, stickpack dispenser, polyethylene bag, polymeric bead, or rubber septum) for holding and releasing pheromone attractant compositions or formulations.

Without wishing to be bound by theory, it is believed that an electromagnetic field that is generated by an electronic device, such as an electric zapper, can modify ant behavior by attracting tawny crazy ants to the electronic device. By combining a pheromone attractant composition with a device that can generate an electromagnetic field, a potential synergistic attraction can result, where a greater than the cumulative individual attraction of tawny crazy ants by the pheromone attractant composition and the electronic device can be observed.

In some embodiments, the trap, bait, or bait station can contain one or more pheromone attractant formulations or compositions, each in a distinct dispenser. For example, the trap, bait, or bait station can include a first pheromone attractant formulation or composition that includes one or more of n-undecane, 2-tridecanone, n-decane, 1-undecene, n-tridecane, 2-dodecanone, 2-tetradecanone, and 2-pentadecanone in a first dispenser. The trap, bait or bait station can further include a second pheromone formulation or composition that includes formic acid in a second dispenser. The first and second dispensers can be placed next to each another, such that the pheromone components contained in the separate dispensers can be considered to be a single composition emanating from a single point source. In some embodiments, two or more pheromones components (e.g., n-undecane, 2-tridecanone, n-decane, 1-undecene, n-tridecane, 2-dodecanone, 2-tetradecanone, and/or 2-pentadecanone) contained in two or more separate dispensers that are placed next to each other, such that the pheromone attractant compositions can be considered to emanate from the same point source.

In some embodiments, the pheromone attractant composition is part of a tawny crazy ant bait station. The bait station can include a food bait, which can be mixed with the pheromone attractant composition or separate from the pheromone attractant composition. The food bait can be in the form of a solid, paste, liquid, or gel. In some embodiments, the food bait is in the form of a granular bait that can, for example, be used for broadcasting. In some embodiments, the food bait is in the form of a gel bait in a syringe that can, for example, be used for direct application at corners or into cracks and crevices. The food bait can be mixed with a toxicant. In some embodiments, the food bait in the bait station is separate from the toxicant, such that the bait station is considered to be a virtual bait station. In some embodiments, the bait station does not include a food bait, but includes the pheromone attractant composition, such that the bait station is also considered to be a virtual bait station.

The food bait can include, for example, amino acids, proteins, carbohydrates (e.g., sugars, starches), fats, and sterols. Non-limiting examples of food baits include sucrose, fructose, glucose, maltose, confectioner's sugar, brown sugar, maple sugar, honey, syrups, molasses, milk solids, flour, fish meal, seed meal, peanut butter, cereals, egg yolk, and vegetable oils.

Exemplary toxicants include fipronil, boric acid, sodium tetraborate, disodium octaborate tetrahydrate, hydramethylnon, indoxacarb, dinotefuran, abamectin, fenoxycarb, spinosad, propoxur, methoprene, or any combination thereof.

While representative food baits and toxicants have been listed above, it is to be appreciated that other food baits and toxicants not specifically listed above can also be used.

### Method of Use

As discussed above, the pheromone attractant composition and formulations can be used as part of an ant trap or a bait station, or standalone bait. In some embodiments, the trap containing the pheromone attractant composition is placed near areas where tawny crazy ants are found, such that they may be attracted to and enclosed in the trap. The ant traps can be used for monitoring the dispersals and infestations of invasive tawny crazy ants, or for killing the tawny crazy ants by mass-trapping. In some embodiments, a bait station including the pheromone attractant composition can be placed near areas where tawny crazy ants frequent (e.g., 2-10 meters from a tawny crazy ant nest), such that they may be attracted to the bait stations, and bring back to their colonies toxicants from the bait stations to kill the colony. A bait station that includes a pheromone attractant composition can have improved attraction of the tawny crazy ant to the food bait, compared to a bait station that does not have a pheromone attractant. In some embodiments, a bait station that includes a pheromone attractant composition can be used in virtual bait stations without any food bait, or with food baits that are separate from toxicants.

For example, the pheromone attractant composition can be mixed with solid granular toxicant food baits, which can be used in broadcasting, or mixed with gel toxicant food baits for direct application at corners or into cracks and crevices. In some embodiments, the pheromone attractant composition is mixed with insecticide sprays (toxicant liquid solutions) to improve the barrier control efficacy.

The following examples are provided for the purpose of illustrating, not limiting, the invention. The examples indicated that volatile pheromones from Dufour's glands and poison glands (as well as their synergistic combination) play important roles in the chemical communication system of N. fulva, especially in the rapid local recruitments of nestmates to the point-sources. Such local recruitments via air-bone volatile pheromones could be an extremely efficient approach to attract surrounding foraging workers (nestmates) for retrieval of large size of food items, mass-attacks on live preys or group defense against enemies collectively and cooperatively. Without wishing to be bound by theory, it is believed that this could explain why the N. fulva workers accumulate in massive numbers in electrical equipment, causing short circuits and clogging switching mechanisms resulting in equipment failure. Specifically, tawny crazy ants can aggregate or be attracted to the electrified ants from which volatile compounds from poison glands and Dufour's glands are discharged. Thus, the more pheromones are released from these ants, the more N. fulva workers were attracted to the location where the ants are aggregated (and electrocuted).

The synthetic point-source pheromone attractants (identified from Dufour's glands and poison glands) described herein can be easily applied in ant traps for monitoring the dispersals and infestations of these invasive crazy ant species, for mass-trapping, or both. The pheromone attractants can also be incorporated into ant bait systems (bait stations, gel baits in syringes, or solid granular broadcast formulations) to improve the attraction of the food baits; and even can be used as standalone pheromone attractants in new virtual bait stations without any food baits. Furthermore, the pheromone attractants can be mixed directly with insecticide sprays for enhancing barrier control efficacy.

### Example 1

N. fulva workers and queens were taken from freshly established laboratory colonies, collected from field at East Columbia, Tex., USA (29° 8′25.96″N; 95° 37′4.48″W) in late spring. Five un-disturbed workers or 1 queen were placed into 2-ml glass vials each preloaded with 1 ml of pentane; a total of 50 workers (5 workers/vial) and 10 queens (1 queen/vial) were sampled. Additional 15 N. fulva workers (5 workers/vial) and 2 N. fulva queens (1 queen/vial) from the lab colonies were extracted in methanol (1 ml per vial) in late fall to determine the existence of formic acid from poison glands. All the crazy ant extract samples (from late spring and late fall) were shipped to Sterling International, Inc. (Spokane, Wash.) within 24-48 hrs of sampling, and kept in −20° C. before GC-MS analysis. Pilot extraction tests with various formicinae ants showed that whole body extraction with pentane was sufficient to extract all the non-polar contents of Dufour's glands, while methanol was an excellent solvent for extracting the polar compounds from poison gland, such as formic acid. Each extract was concentrated under N₂ to 100 μl and 10 μg of octyl butyrate was added to each extract sample, as an internal standard (IS), before GC-MS analysis.

### GC-MS Analyses

All the extract samples (2 μl each) were analyzed in a splitless mode by coupled gas chromatography-mass spectrometry (GC-MS) on an Agilent 6890N gas chromatograph (GC) linked to an Agilent 5973N mass selective detector (MSD) equipped with a polar column (INNOWAX; 60 m×0.25 mm×0.5 μm film thickness; Agilent Technologies, Wilmington, Del., USA). The GC was programmed at 50° C. for 1 min, 10° C./min to 230° C., and held at 230° C. for 25 min. Injector and transfer line temperatures were 250° C. Helium was used as carrier gas at a constant flow of 26 cm per second. Compounds were identified by comparing their retention times and mass spectra with those of authentic standards. Quantifications of Dufour's gland compounds were carried out based on the relative contents to the internal standard (IS) (10 μg of octyl butyrate IS per sample). Formic acid was not quantified in the current study; however, published data were considered when designing the field trapping experiments, as described, for example, in Chen et al. (2013) Toxicon 76:160-166, herein incorporated by reference in its entirety.

The following synthetic compounds were obtained from various commercial sources: n-decane (99%, Tokyo Chemical Industry Co., Ltd.; TCI), n-undecane (99%; Sigma-Aldrich), 1-undecene (97%; Sigma-Aldrich), n-tridecane (99%; Sigma-Aldrich), 2-dodecanone (>95%; TCI), 2-tridecanone (>95%; TCI), 2-tetradecanone (>95%; TCI), 2-pentadecanone (>95%; TCI), formic acid (>98%; Fluka; now part of Sigma-Aldrich), and octyl butyrate (>99%; Sigma-Aldrich).

### Field Trapping Experiments

Nine field trapping experiments were carried out in an old oak woodland with sandy soil and low grass understory at La Marque, Tex., USA (29° 21′23.73″N; 95° 0′9.47″W), using Terro® “Spider & Insect Traps” (sticky traps; Woodstream Corporation, Lititz, Pa.) or Rescue!® crawling insect sticky traps (described, for example in U.S. Application Publication No. 2013/0318860 A1, herein incorporated by reference in its entirety). All the tested dispensers were placed in the center of sticky surface on the bottom of the trap. An unbaited sticky trap was included in each experiment block for all the experiments as a blank control.

Experiments 1 and 2 were conducted simultaneously in summer. Exp. 1 tested two synthetic Dufour's gland pheromone candidate mixtures identified from N. fulva workers (treatment “A”: a mix of eight compounds at near natural ratios from workers: n-undecane, 2-tridecanone, n-decane, 1-undecene, n-tridecane, 2-dodecanone, 2-tetradecanone, 2-pentadecanone; 41:53:1.2:0.5:1:2:0.3:1) and queens (treatment “B”: a mix of four compounds at near natural ratios: n-undecane, 2-tridecanone, n-tridecane and 2-pentadecanone; 54:40:1:5) plus a synthetic binary blend of the two major components (undecane and 2-tridecanone at 50:50 ratio) identified from both workers and queens (treatment “C”) (Table in FIG. 3) using centrifuge tube dispensers with low loading (30 mg each mixture on a small cotton ball inside an open cap 2-ml centrifuge dispenser) at about 2 mg/day (mg/d) release in a randomized block design (6 blocks) using Terro® “Spider & Insect Traps”. Traps were placed on the ground in lines with 2 meters (m) between traps within each set, 3 m between trap sets. Exp. 2 had exactly the same treatments, replicate #, trap type and trap placement protocol as in the Exp. 1, but used different type of dispensers (stickpacks) (described, for example, in U.S. Application Publication No. 2012/0280055, herein incorporated by reference in its entirety) with same loading amount (30 mg each mix in 500 μl canola oil (CO)/dispenser) at similar overall release rates (2.3 mg/d). Experiment 2 was distanced about 15 m away from Exp. 1. The tawny crazy ant population level at the testing site was relatively high and ubiquitous throughout the landscape, as the tawny crazy ant population was actively foraging over the entire surface of the woodland understory and up every tree. The weather was sunny with a mean daily temperature of 28.6° C.

Experiments 3 and 4 were conducted simultaneously in the fall. Exp. 3 tested two synthetic Dufour's gland pheromone candidate mixtures mimicking the N. fulva workers (treatment “A”: a mix of eight compounds; 100 mg loading) and queens (treatment “B”: a mix of four compounds; 100 mg loading) using centrifuge dispensers (with one small cotton ball in each) with low release rate (ca. 2 mg/d), one positive control (treatment “C”: yellow plastic cap loaded with 1 g of Advance® Granular Carpenter Ant Bait, BASF Corporation, NJ, USA), plus a blank control (“D”), in a randomized block design (6 blocks/sets) using the Rescue!® crawling insect sticky traps. Same as in Exp. 1-2, the traps were placed were placed on the ground in lines with 2 m between traps within each set, 3 m between trap sets. Exp. 4 examined the same treatments, replicate # and trap types as well as the trap placement protocol as were in the Exp. 3, but utilized different type of dispensers (stickpacks) with higher release rates (8-12 mg/d) for “A” and “B”. Exp. 4 was distanced 20 m from Exp. 3. The weather was sunny with a mean daily temperature of 23.4° C. for days 1 and 2. On Day 3 the weather was overcast with a mean daily temperature of 25.3° C. and 0.97 cm of rainfall.

Experiments 5 and 6 were conducted simultaneously in late fall. Exp. 5 tested potential attraction of N. fulva workers to a synthetic mixture mimicking the full blend of N. fulva worker Dufour's gland pheromone (treatment “A”: a mix of eight compounds; 100 mg mixed with 400 μl canola oil (CO) from a stickpack dispenser; 8-12 mg/d), a synthetic pheromone candidate of N. fulva poison gland, formic acid (FA) (treatment “B”; 438 mg FA mixed with 812 mg of polyurethane inside an open 2-ml centrifuge tube; at 27-30 mg/d release) and their combination (treatment “C”) plus a blank control (“D”) in a randomized block design (6 blocks/sets) using the Rescue!® crawling insect sticky traps. Traps were again placed on the ground in lines with 2 m between traps within each set, 3 m between trap sets. Exp. 6 tested the same treatments as did in Exp. 2, but with 100 mg loading instead of the 30 mg in a randomized block design (6 blocks/sets) using the stickpack dispensers (at 8-12 mg/d releases) and Rescue!® crawling insect sticky traps. Exp. 6 was about 20 m way from Exp. 5. The weather was rainy with a mean daily temperature of 12.0° C. and 3.6 cm of rain. N. fulva worker were not actively foraging.

Experiment 7 repeated the Exp. 5 and was conducted during the summer, when there is a much higher ant foraging activity. Experiment 8 tested the three major components, n-undecane and 2-tridecanone (identified from Dufour's glands) plus formic acid (identified from poison glands), in a full factorial experimental design (with 6 sets) i.e., all components, binary and ternary blends, using the Rescue!® crawling insect sticky traps during the fall. n-Undecane (100 mg mixed with 1400 μl CO) and 2-tridecanone (100 mg mixed with 400 μl CO) were released separately from stickpack dispensers, at about 6-7 and 1 mg/day release rates, respectively, whereas the formic acid (438 mg mixed with 812 mg of polyurethane) was released from an open 2-ml centrifuge tube; at 27-30 mg/d release. Experiment 9 was carried out during the fall, tested n-undecane (150 mg mixed with 1350 μl CO; at 9-11 mg/d release) alone from stickpack, against a blend of three major components including n-undecane (150 mg) and 2-tridecanone (50 mg) mixed with 1300 μl CO from same stickpack at 10-12 mg/d overall release, plus formic acid (438 mg mixed with 812 mg of polyurethane) from an open 2-ml centrifuge tube at 27-30 mg/d release, and a full blend consisting of eight worker Dufour's gland volatile compounds (at near natural ratios; 200 mg mixed with 1300 μl CO; at 10-12 mg/d overall release) in one stickpack plus formic acid (438 mg mixed with 812 mg of polyurethane) from an open 2-ml centrifuge tube at 27-30 mg/d release.

### Data Collection and Statistical Analysis

Traps were checked once per day except Exp. 5-6 (only one visit at day 3) for 2-3 days post deployment. A digital picture was taken of each trap during each trap visit and the numbers of workers captured on each trap were recorded on site or in lab via pictures. Trap catch data were transformed by Log (X+1) or arcsin √P (P: relative catches per replicate) to achieve normal distributions and homogeneous variances, and the transformed means were analyzed by analysis of variance (ANOVA), followed by the Duncan's multiple-range test (SPSS 16.0 for Windows) at α=0.05.

### Results

Chemical Analysis

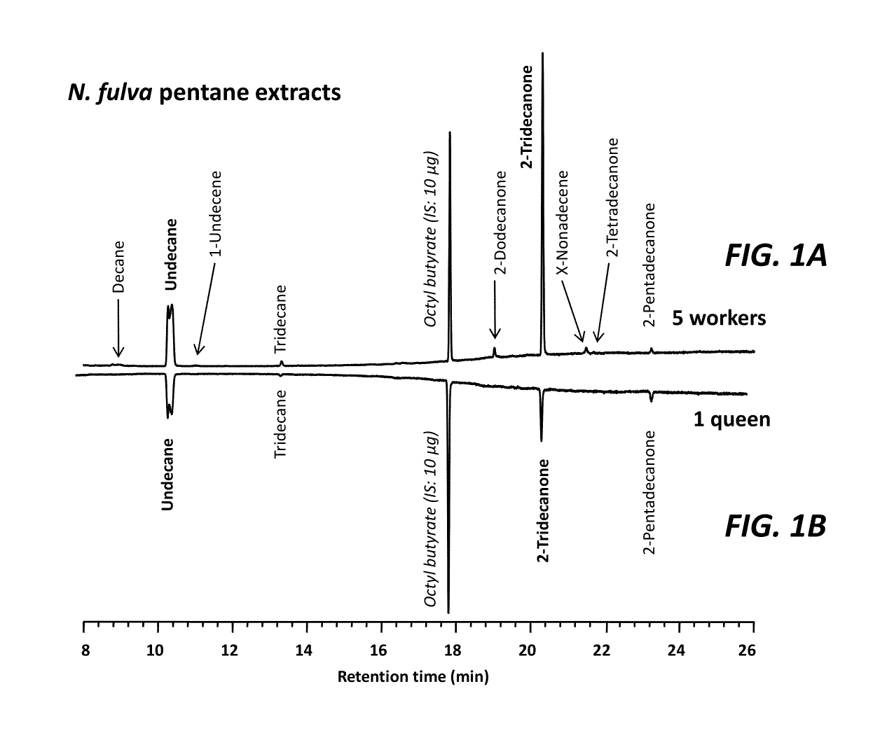

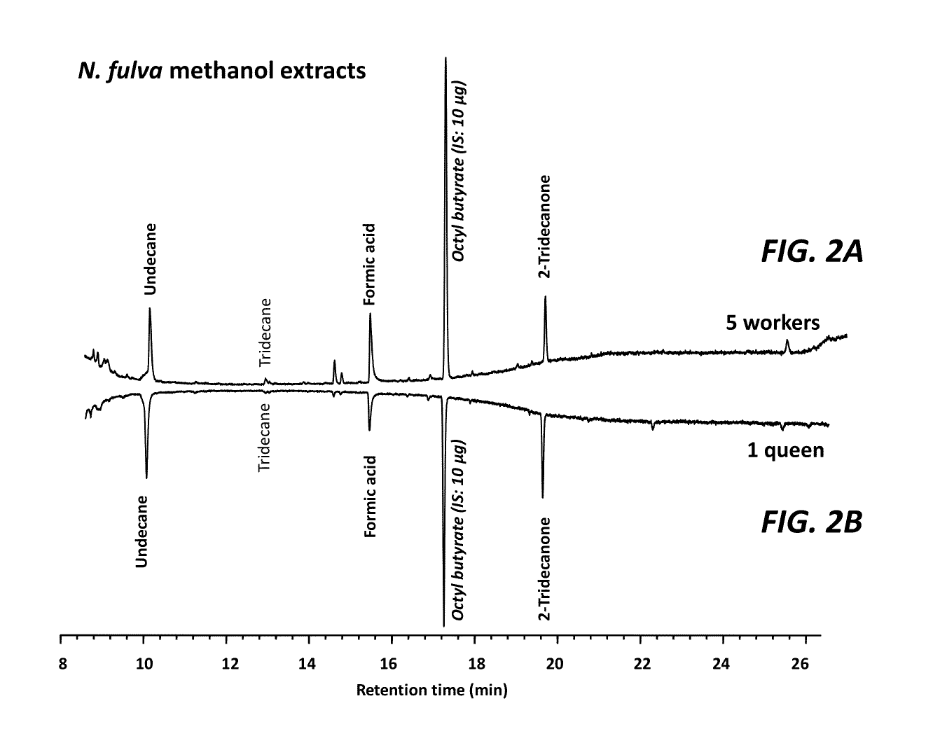

GC-MS analysis on the whole body pentane extracts showed that Dufour's glands of N. fulva workers produced at least nine volatile compounds, with n-undecane and 2-tridecanone being the two major components (accounting for >92% of total volatiles), and n-decane, 1-undecene, n-tridecane, x-nonadecene, 2-dodecanone, 2-tetradecanone, 2-pentadecanone as minor components (Table in FIG. 3, and FIG. 1A). Dufour's glands of N. fulva queens contained the same two major compounds as the workers, but had only two minor components, n-tridecane and 2-pentadecanone (Table in FIG. 3 and FIG. 1B). The absolute quantities of volatile compounds are shown in Table in FIG. 3. Even though N. fulva queens produced less numbers of the volatile compounds in their Dufour's glands, but their overall volatile contents (10.93 μg/queen) were much higher than those of the workers (6.21 μg/worker). The production of these hydrocarbons and 2-ketones by Dufour's glands was confirmed by further Dufour's gland extractions (data not shown). No formic acid was detected from the whole body pentane extracts of both N. fulva workers and queens. However, significant amount of formic acid was detected from the whole body methanol extracts of both workers (FIG. 2A) and queens (FIG. 2B). No effort on quantification of formic acid was made; but further methanol extractions of poison glands confirmed the production of formic acid from the poison glands.

Thus, the tawny crazy ants (N. fulva) show a Dufour's gland chemistry with n-undecane and 2-tridecanone as two major components (FIGS. 1A, 1B, 2A, and 2B); the average amounts of Dufour's gland pheromone in N. fulva were 6.21 μg per worker and 10.93 μg per queen. Formic acid was found to be the major (if not the only) component of the poison gland for all the Formicinae ants, including N. fulva (FIGS. 2A and 2B). Similar GC-MS analysis results, i.e., formic acid from poison gland and n-undecane and 2-tridecanone from Dufour's gland of the tawny crazy ants, were recently reported reported by Chen et al. (2013) Toxicon 76:160-166; but they were considered as major defensive chemicals, showing strong contact/fumigation toxicity to workers of the red imported fire ants.

Field Trapping Experiments

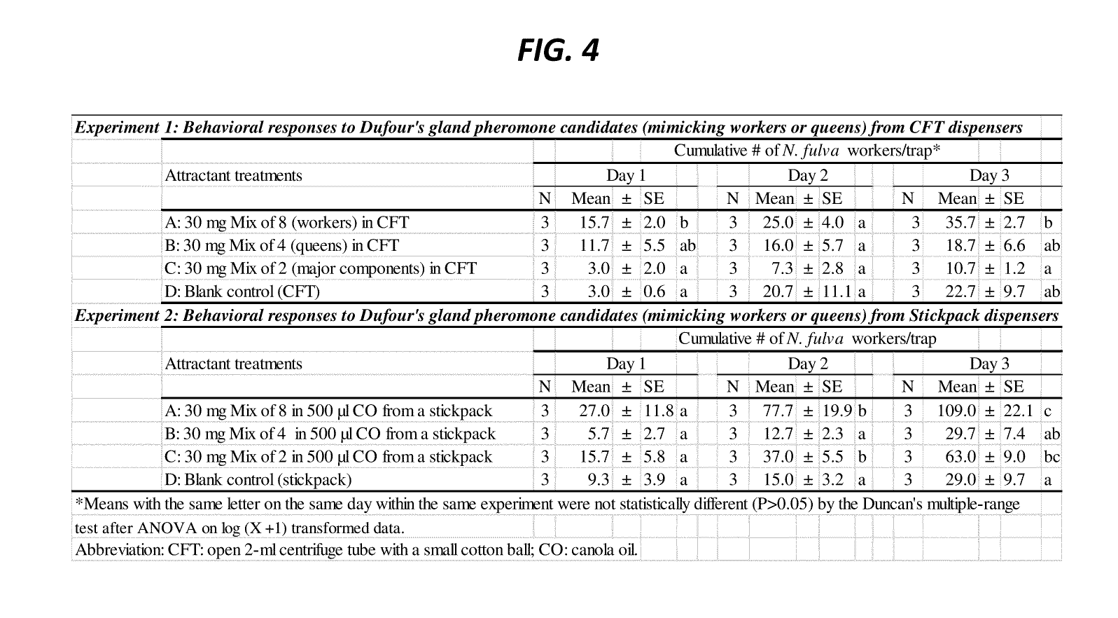

Exp. 1 tested the different synthetic mixtures of Dufour's gland pheromone candidates mimicking N. fulva workers or queens in summer. As shown in Table in FIG. 4, the 30 mg of mixture of 8 (worker Dufour's gland volatiles: n-undecane, 2-tridecenone, n-decane, 1-undecene, n-tridecane, 2-dodecanone, 2-tetradecanone, and 2-pentadecanone) released from CFT dispensers at about 2 mg/d and the mixture of 4 (mimicking N. fulva queen Dufour's gland: n-undecane, 2-tridecanone, n-tridecane and 2-pentadecanone) showed slightly higher trap catches than did the blank control at day 1, whereas the mixture of two major components (undecane and 2-tridecanone) was not different from the blank control. At day 2 and day 3, no significant differences in trap catches among the treatments were found (Table in FIG. 4). The same Dufour's gland pheromone candidate treatments were also tested in Exp. 2 using stickpack dispensers with similar releases. Significant attractions to N. fulva workers were recorded in traps baited with the mixture of 8 and the mixture of 2 major components at day 2 and day 3. The overall trap catches were relatively low for both experiments, which might be due to weak attraction of the tested chemicals or low ant foraging activity or both.

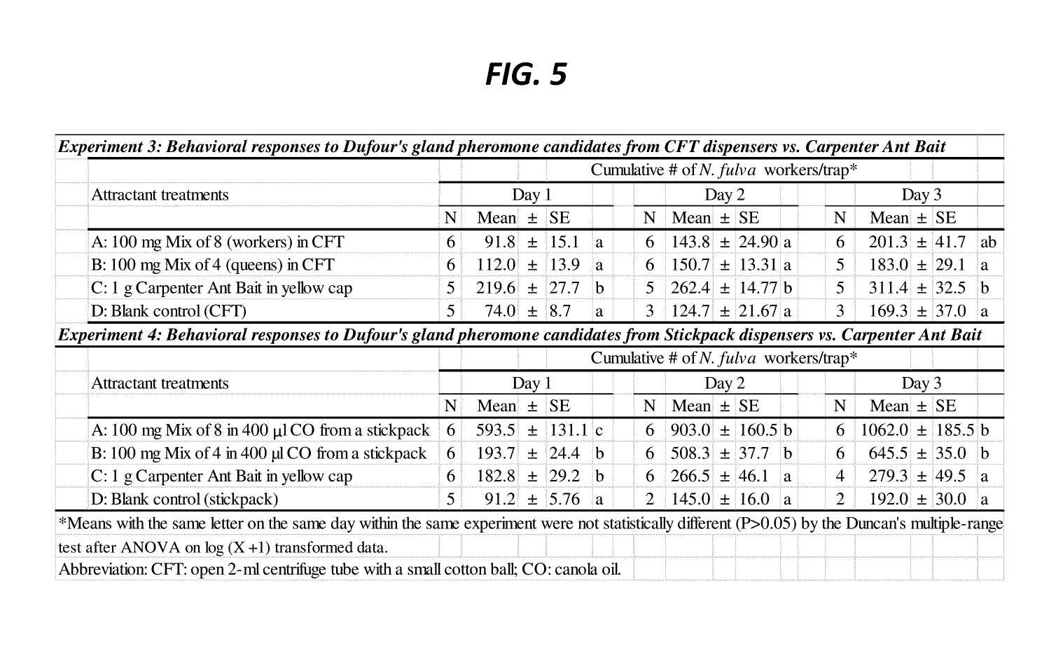

Exp. 3 tested both the mixture of 8 and the mixture of 4 from CFT dispensers against the Advance Carpenter Ant Bait (positive control; known attractive bait for N. fulva) during the high population season. Even though traps baited with either mixture caught somewhat more N. fulva workers than did the blank control traps, no significant attraction to either one was detected; however, Advance® Granular Carpenter Ant Bait from open yellow cap showed significantly higher trap catches (2-3 times higher) than did the blank control for all the three days (Table in FIG. 5). The same Dufour's gland pheromone candidate treatments were also tested against the same positive control (Advance® Granular Carpenter Ant Bait) in Exp. 4 using stickpack dispensers with much higher release rates (8-12 mg/d). The positive control caught similar numbers of N. fulva workers at day 1-3 as did in Exp. 3. Surprisingly, the synthetic Dufour's gland pheromone mixtures from stickpack dispensers with high release rates showed 3-6 times more trap catches than did the blank control and 2-3 times higher than did the carpenter ant baits for all three days (Table in FIG. 5). The mixture of 8 seemed to be more attractive than was the mixture of 4 at least at day 1.

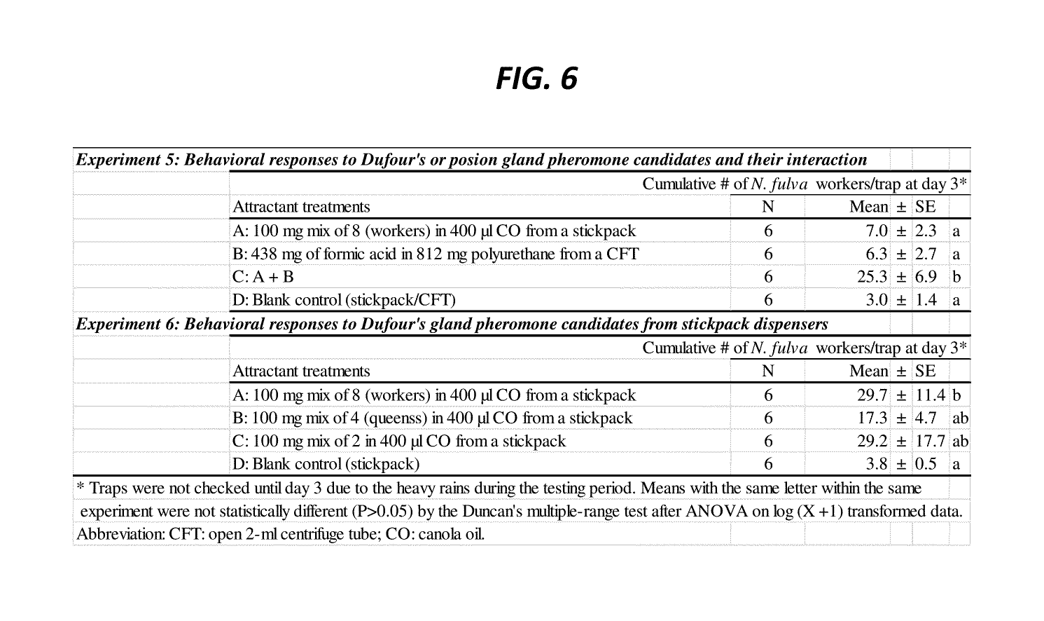

Exp. 5 tested N. fulva worker Dufour's gland pheromone mixture (mix of 8), poison gland pheromone, formic acid, and their combination during the late fall. Due to the extremely low temperature and continuous rain-falls, only a few foraging workers were captured in the experiment. Traps baited either Dufour's gland pheromone mixture or the poison gland pheromone (formic acid) caught twice as many N. fulva workers as did the blank control, but no significant differences were detected. However, traps baited with combination of the Dufour's gland pheromone mixture and formic acid caught significantly more (7 times) N. fulva workers than did the blank control traps, and 3-4 times more than did either Dufour's gland pheromone or poison gland pheromone, indicating a strong synergism (Table in FIG. 6). Exp. 6 repeated Exp. 2, but with higher loading and release rates of tested pheromone candidates. Only the mixture of 8 showed statistically higher trap catches than did the blank control, even though the other two mixtures were also 4-8 times higher than was the blank (Table in FIG. 6), due to the extremely low foraging activities and bad weather.

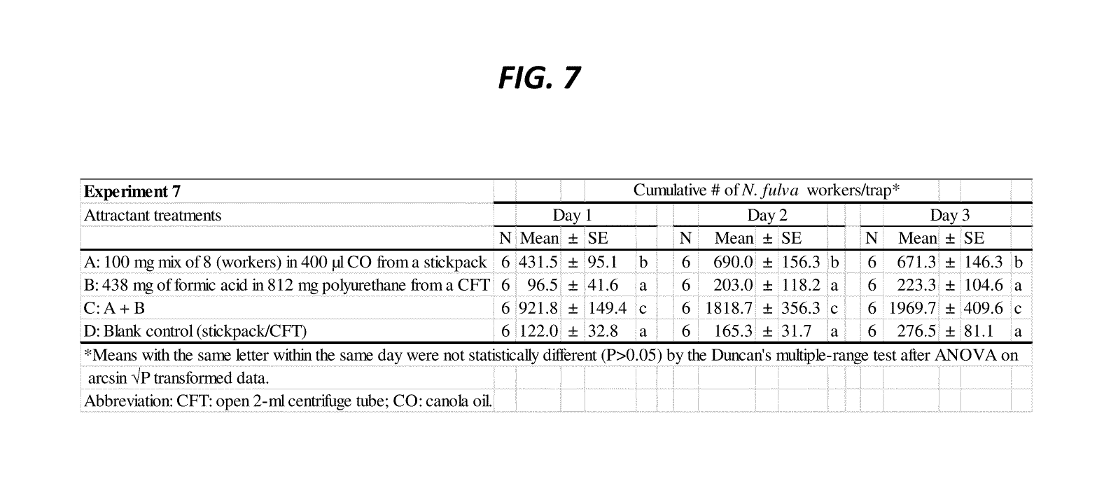

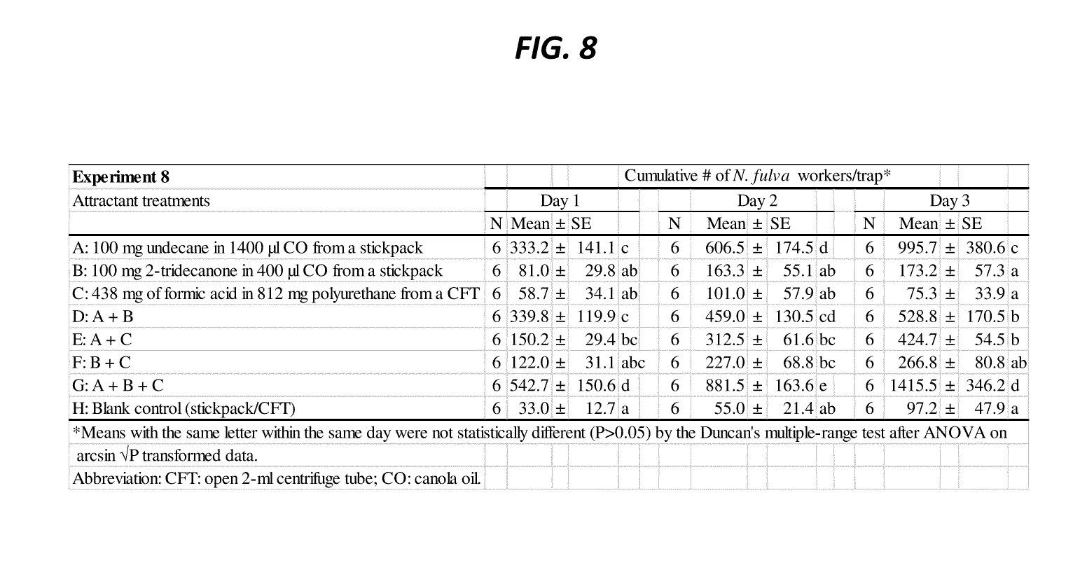

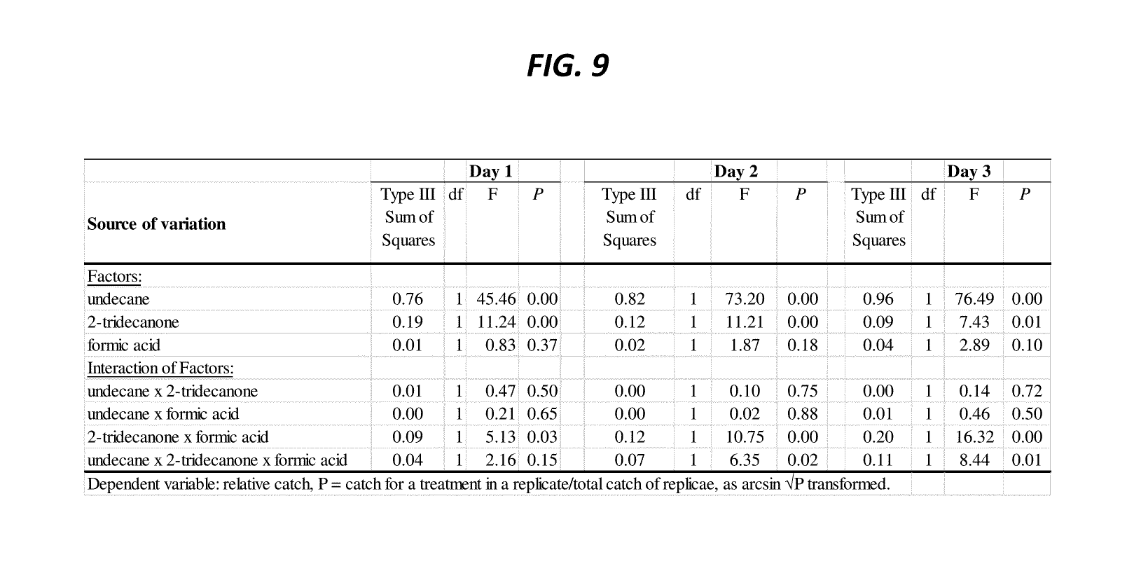

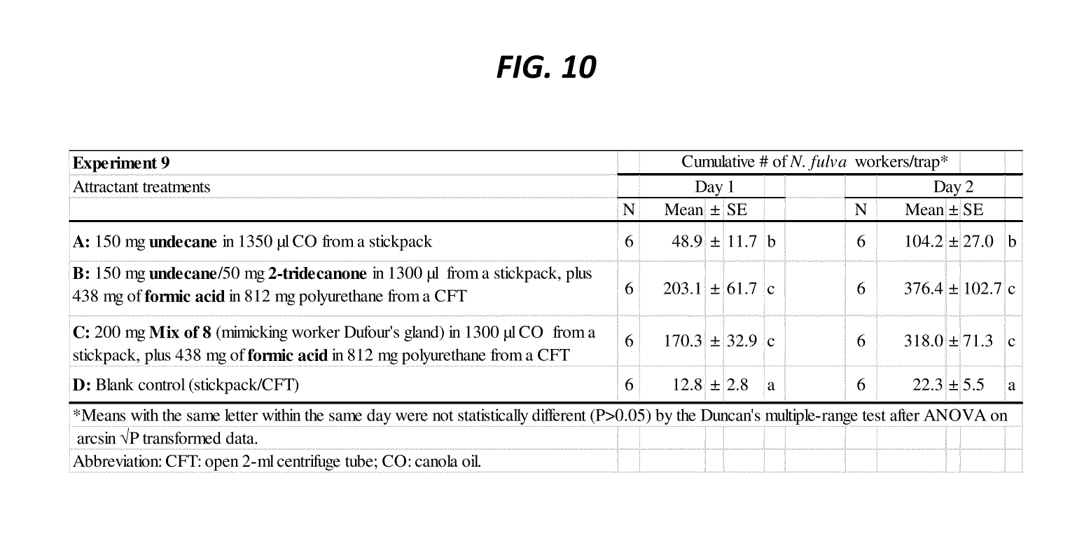

Exp. 7 had the same treatments as did the Exp. 5, but was carried out in the summer with high ant populations. Formic acid alone was inactive, but the Dufour's gland pheromone mixture (mix of 8) was significantly attractive (Table in FIG. 7). Their combinations showed 5 and 2 times higher trap catches than did the blank control and the mix of 8, respectively, in a synergistic fashion for all three days (Table in FIG. 7). In Exp. 8, 2-tridecenone or formic acid alone was not different from the blank control, but n-undecane alone was significantly attractive for the three days (Table in FIG. 8). Their binary blends were also significantly attractive in most cases, but were not more efficient than did the n-undecane alone. In fact, in some cases, adding 2-tridecenone or formic acid to n-undecane even reduced trap catches (Table in FIG. 8). Surprisingly, the combination of all the three major components, n-undecane, 2-tridecenone and formic acid, showed a significant three-way synergistic interaction (Table in FIG. 9; at least for day 2 and day 3), resulting in significantly higher trap catches than did the second best attractant candidate treatment (undecane alone) for all three days (Table in FIG. 8). Exp. 9, again confirmed that n-undecane alone was weakly, but significantly attractive to the tawny crazy any workers, whereas the combination of the major three components, n-undecane, 2-tridecenone and formic acid, and mixture of 8 Dufour's gland volatiles plus formic acid were equally and significantly more attractive than was n-undecane alone for both two days (Table in FIG. 10).

Thus, synthetic Dufour's gland pheromones mimicking the workers, queens or a mixture of two its major components (undecane and 2-tridecanone) and poison gland pheromone (formic acid) as well as their synergistic combinations were shown for the first time to be strongly attractive to N. fulva workers to the sticky ant traps in the field; these pheromones play important roles in the chemical communication system of N. fulva, especially in the rapid local/short-range recruitments of nestmates to the point-sources. Even though they might function as a short-range (2 m or so) point-source recruitment pheromone signal in the nature with low release rate at ng/day to μg/day levels from single scout ants, the synthetic pheromones at high release rates (at many hundreds to thousands fold compared to nature, or 1-30 mg/day) can have a strong long-range attraction effect, therefore, can have great potential as an efficient ant attractant for traps or baits. Indeed, the strong attractant effect of the high release rates was unexpected and unpredictable, because many pheromones are attractive at low release rates but become inactive or repellent at high release rates.

Unless otherwise defined, all technical and scientific terms used herein have the same meaning as commonly understood by one of ordinary skill in the art. Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A tawny crazy ant attractant, comprising
a first composition comprising a first carrier and one or more pheromone components comprising n-undecane and 2-tridecanone; and
a second composition comprising a second carrier and formic acid.

2. The tawny crazy ant attractant of claim 1, wherein the one or more pheromone components volatilize at a rate of 0.1 to 100 mg/day.

3. The tawny crazy ant attractant of claim 2, wherein the one or more pheromone components volatilize at a rate of 0.1 to 10 mg/day.

4. The tawny crazy ant attractant of claim 1, wherein the formic acid volatilizes at a rate of 0.1 mg/day to 100 mg/day.

5. The tawny crazy ant attractant of claim 1, wherein the n-undecane is present in an amount of from 50% to 90% by weight, based on the total weight of the one or more pheromone components in the first composition.

6. The tawny crazy ant attractant of claim 1, wherein the 2-tridecanone is present in an amount of from 10% to 50% by weight, based on the total weight of the one or more pheromone components in the first composition.

7. The tawny crazy ant attractant of claim 1, wherein the one or more pheromone components further comprise n-tridecane and 2-pentadecanone.

8. The tawny crazy ant attractant of claim 7, wherein the n-undecane is present in an amount of from 49.8% to 89.8% by weight, based on the total weight of the one or more pheromone components in the first composition.

9. The tawny crazy ant attractant of claim 7, wherein the 2-tridecanone is present in an amount of from 10% to 50% by weight, based on the total weight of the one or more pheromone components in the first composition.

10. The tawny crazy ant attractant of claim 7, wherein the n-tridecane is present in an amount of from 0.1% to 30% by weight, based on the total weight of the one or more pheromone components in the first composition.

11. The tawny crazy ant attractant of claim 7, wherein the 2-pentadecanone is present in an amount of from 0.1% to 30% by weight, based on the total weight of the one or more pheromone components in the first composition.

12. The tawny crazy ant attractant of claim 1, wherein the one or more pheromone components further comprise n-decane, 1-undecene, n-tridecane, 2-dodecanone, 2-tetradecanone, and 2-pentadecanone.

13. The tawny crazy ant attractant of claim 12, wherein the n-undecane is present in an amount of from 49.4% to 89.4% by weight, based on the total weight of the one or more pheromone components in the first composition.

14. The tawny crazy ant attractant of claim 12, wherein the 2-tridecanone is present in an amount of from 10% to 50% by weight, based on the total weight of the one or more pheromone components in the first composition.

15. The tawny crazy ant attractant of claim 12, wherein the n-tridecane is present in an amount of from 0.1% to 5% by weight, based on the total weight of the one or more pheromone components in the first composition.

16. The tawny crazy ant attractant of claim 12, wherein the 2-pentadecanone is present in an amount of from 0.1% to 5% by weight, based on the total weight of the one or more pheromone components in the first composition.

17. The tawny crazy ant attractant of claim 12, wherein the n-decane is present in an amount of from 0.1% to 5% by weight, based on the total weight of the one or more pheromone components in the first composition.

18. The composition of claim 12, wherein the 1-undecene is present in an amount of from 0.1% to 5% by weight, based on the total weight of the one or more pheromone components in the first composition.

19. The composition of claim 12, wherein the 2-dodecanone is present in an amount of from 0.1% to 5% by weight, based on the total weight of one or more pheromone components in the first composition.

20. The composition of claim 12, wherein the 2-tetradecanone is present in an amount of from 0.1% to 5% by weight, based on the total weight of one or more pheromone components in the first composition.

21. The composition of claim 1, wherein the first carrier is selected from the group consisting of a vegetable oil and a mineral oil.

22. The composition of claim 1, wherein the second carrier is a polymer.

23. The composition of claim 1, further comprising a food bait.

24. A device comprising a tawny crazy ant attractant of claim 1, comprising
a first dispenser comprising the first composition comprising one or more pheromone components comprising n-undecane and 2-tridecanone in the first carrier; and
a second dispenser comprising the second composition comprising formic acid in the second carrier.

25. The device of claim 24, wherein the one or more pheromone components volatilize from the first dispenser at a rate of 0.1 to 100 mg/day.

26. The device of claim 24, wherein the formic acid volatilizes from the second dispenser at a rate of 0.1 mg/day to 100 mg/day.

27. The device of claim 24, wherein the device is selected from the group consisting of a trap, an electric zapper, and a bait station.

28. The device of claim 24, wherein the device further comprises a toxicant.

29. A method of attracting tawny crazy ants, comprising:
providing a tawny crazy ant attractant of claim 1 in a device;
placing the device in a location frequented by tawny crazy ants; and
attracting the tawny crazy ants to the device.

30. A method of attracting tawny crazy ants, comprising:
providing a composition comprising n-undecane in a first carrier;
placing the composition in a location frequented by tawny crazy ants; and
attracting the tawny crazy ant to the device.

31. The method of claim 30, wherein the composition consists essentially of n-undecane in a first carrier.
